(19) United States
(12) Patent Application Publication
(10) Pub. No.: US 2015/0338355 A1
(43) Pub. Date: Nov. 26, 2015

(54) X-Ray Apparatus for Detecting a Flaw of Small Sized Article Continuously

(71) Applicant: Xavis Co., Ltd., Gyeonggi-do (KR)

(72) Inventors: Hyeong-Cheol Kim, Gyeonggi-do (KR); Deok-Hyun Ryu, Gyeonggi-do (KR); Taek-Geun Jeong, Gyeonggi-do (KR); Doo-Yong Jo, Gyeonggi-do (KR); Hyeon-Ju Noh, Seoul (KR)

(21) Appl. No.: 14/323,859

(22) Filed: Jul. 3, 2014

(30) Foreign Application Priority Data
May 21, 2014 (KR) 10-2014-0060824

(51) Int. Cl. G01N 23/02

(52) U.S. Cl. CPC G01N 23/02

(57) ABSTRACT

The present invention relates to an x-ray apparatus for detecting a defect of small-sized articles continuously. The x-ray apparatus comprises an inspection module having an x-ray tube and a detector; a conveying module configured to convey an inspection target within the inspection module continuously; an inputting unit and an outputting unit installed at an entrance and an exit of the inspection module R; a shielding member displaced at an entering portion formed in the inputting unit; and a fixing guide formed in the conveying module.

### RELATED APPLICATION

This application claims priority to Korean Patent Application No. 10-2014-0060824 filed on May 21, 2014 with the Korean Intellectual Property Office, the disclosure of which is incorporated herein by reference.

### TECHNICAL FIELD

The present invention relates to an x-ray apparatus for detecting defects of small-sized articles continuously and a method for detecting defects of small-sized articles with the same, and more particularly to an x-ray apparatus for detecting defects of small-sized articles continuously that is configured to detect a defect of small-sized article conveyed continuously by a conveyor with high resolution and a method for detecting defects of small-sized articles with the same.

### BACKGROUND

X-ray having a short wavelength is a kind of electromagnetic wave that penetrates into materials and has different penetration depth depending on density and constituent atoms of materials. An x-ray apparatus uses such physical properties of x-ray and apply to inspecting defects of platinum wires or lead frames in electronic parts, defects of copper wires in a printed circuit board (PCB) and various failures of soldering. The x-ray apparatus may also apply to detecting impurities in sealed food products or medicines, detecting defects of mechanical parts or wires in the mechanical parts. The x-ray detection may apply to inspection system for checking defective industrial products in various field for which non-destructive inspection is required.

On inspecting defects of products, products are input into or output from an inspecting room where an x-ray apparatus is installed or each part may be transported in a certain order to inspecting room for detection. But it is difficult to inspect the products continuously and same time to prevent x-ray from being leak. But in case of mass production filed, it is advantageous that an apparatus for inspecting products is installed in the production spot and the inspection proceeds in the production spot. On the other hand, if x-ray is emitted to the inspection objection only at a predetermined angle, e.g., in a vertical direction, impurities or defects of products may be restricted from being detected, depending on products. In addition, it is necessary for resolution of a detector to be properly adjusted during an x-ray inspection process, because high-resolution x-ray images may be required depending on the products. No known x-ray detection method discloses adjustment of an emission direction of x-ray.

### SUMMARY

The purpose of the present invention is to provide with an x-ray inspection apparatus for detecting defects of articles that are transferred continuously fixed in a predetermined location and for adjusting an emitting direction of x-ray.

In an embodiment of the present invention, an x-ray inspection apparatus comprises an inspection module having an x-ray tube and a detector, a conveying module configured for conveying inspection targets continuously within the conveying module; an inputting unit and an outputting unit displaced at an entrance and an exit of the inspection module, respectively; a shielding member arranged at the entering portion of inputting unit; and a fixing guide formed in the conveying module.

In other embodiment of the present invention, an emitting angle of x-ray in the tube is adjusted depending on the inspection targets.

In another embodiment of the present invention, the x-ray apparatus further comprises shielding modules having at least one shielding unit coupled to the inputting unit and the outputting, respectively.

In still another embodiment of the present invention, the fixing guide comprises a pair of strips that extends along a moving direction of the conveying module, and is integrally formed in the conveying module.

### BRIEF DESCRIPTION OF THE DRAWINGS

Features and benefits of embodiments of the claimed subject matter will become apparent as the following detailed description proceeds, and upon reference to the drawings, wherein like numerals depict like parts, and in which:

FIGS. 1A and 1B are a perspective view and a front view of an embodiment of an x-ray apparatus according to the present invention, respectively;

FIGS. 2A and 2B illustrate another embodiment of the x-ray apparatus according to the present invention, respectively;

FIG. 3A illustrates a conveying structure applied to the x-ray apparatus according to the present invention;

FIG. 3B illustrates a shielding structure applied to the x-ray apparatus according to the present invention;

FIG. 3C illustrates another embodiment of a shielding module applied to the x-ray apparatus according to the present invention; and

FIG. 4 illustrates an embodiment of a detector with high resolution applied to the x-ray apparatus according to the present invention.

### DETAILED DESCRIPTION

Reference will now be made in detail to the embodiments of the present disclosure. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

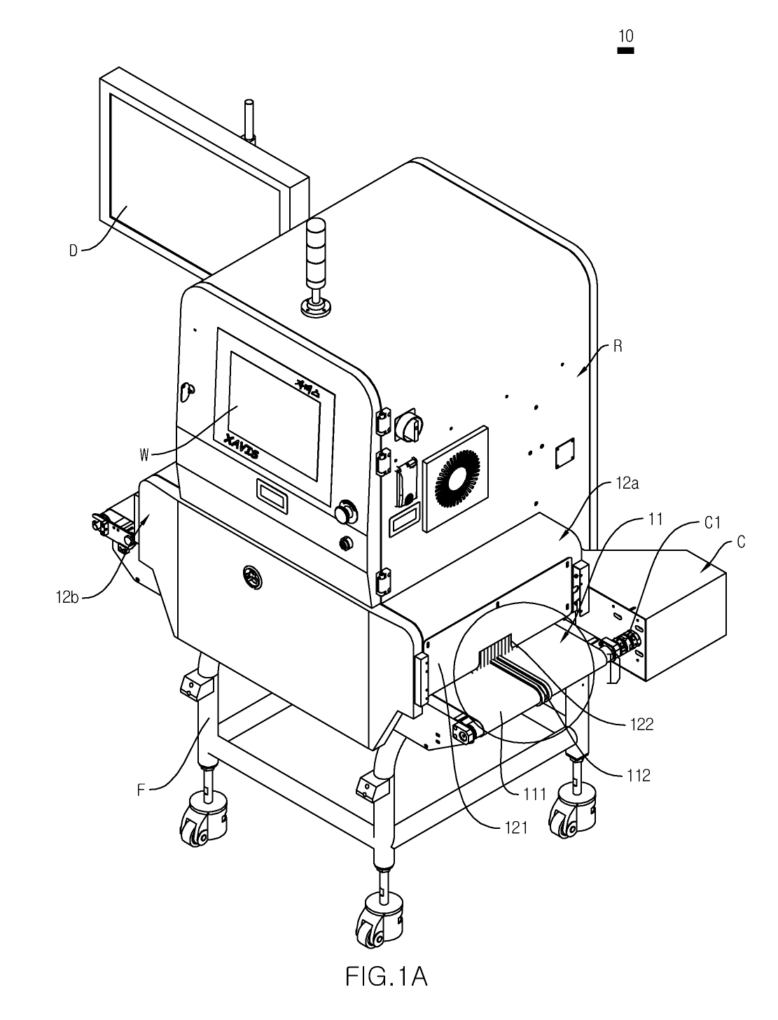

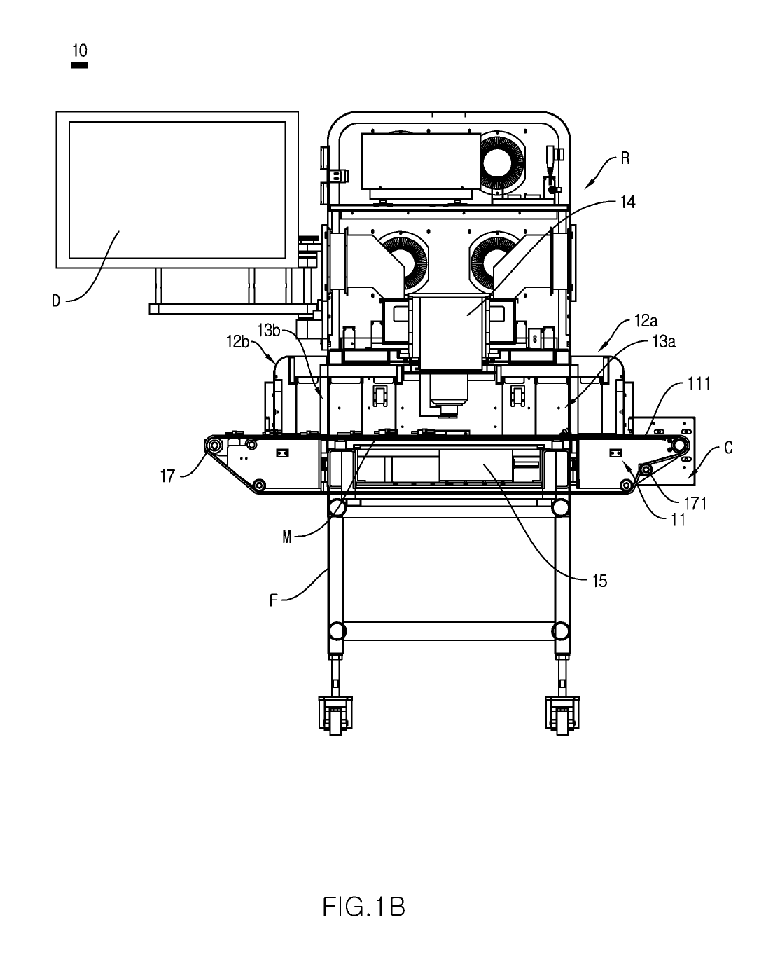

FIGS. 1A and 1B are a perspective view and a front view of an embodiment of an x-ray apparatus 10 according to the present invention, respectively.

Referring to FIGS. 1A and 1B, an x-ray apparatus 10 according to the present invention includes an inspection module R within which an x-ray tube 14 and a detector 15 are displaced in proper location. The inspection module R includes a conveying module 11 for conveying an inspection targets M to an inside of the inspection module R; an inputting unit 12a and an outputting unit 12b installed in an entrance and an exit of the inspection module R, respectively; a shielding member 31 which is arranged in an entering portion of the inputting unit 12a; and a fixing guide 112 which is formed in the conveying module 11.

The x-ray apparatus 10 according to the present invention may apply to inspect a defect of a metal temperature sensor of a vehicle or a defect of sealed food in a container, but not limited thereto. The metal temperature sensor or the container with food may be continuously conveyed by the conveying module 11, and the defect may be detected by the x-ray tube 14 and the detector 15. The inspection module R may have a sealed structure that may accommodate the x-ray tube 14 and the detector 15 therein. The conveying module 11 may include a plurality of rollers 17 that are rotated by a driver such as a motor, and a conveyor belt 111 rotated by the rollers 17. The conveying module 11 may be coupled to a fixing module C which includes a driving device with a connector C1. As necessary, the conveying module 11 may be detachably connected to the inspection module R.

At least one fixing guide 112 may be formed in the conveyor belt 111. The fixing guide 112 may have such a structure that extends in a moving direction of the inspection targets M along the conveyor belt 111, and may be integrally formed in the conveyor belt 111. The at least one fixing guide 112 may be formed in the conveyor belt 111 and this will be explained again later.

The inputting unit 12a and the outputting unit 12b may be installed in a front side and a rear side of the inspection module R, respectively. The inputting unit 12a and the outputting unit 12b may have a similar structure each other, and may be detachably connected to the inspection module R. The inputting unit 12a may include a shielding plate 121 and an entering portion 122 formed in the shielding plate 121. And a shielding member made of a material such as lead and shaped like a strip may be installed in the entering portion 122.

The inspection targets M may be placed on the fixing guide 112 and may be transferred into the inspection module R through the entering portion 122 continuously, and may be inspected by the x-ray tube 14 and the detector 15 in turn. An x-ray image of each inspection target M that is generated by detecting each inspection target M by the detector 15 may be displayed in a display unit D, and an inspection process may be checked through a window W. After the completion of inspection, each inspection target M may be output through the outputting unit 12b which may include a shielding plate and an exit portion. The shielding plate and the exit portion which are formed in the outputting unit 12b may have a structure similar to the structure of the shielding plate 121 and the entering portion 122 which are formed in the inputting unit 12a.

The inspection module R may be installed in a frame F that has a movable structure, and the control unit may control operations of the conveying module 11, x-ray tube 14 and detector 15. The conveying module 11 may have means for adjusting tension of the conveyor belt 111 such as a tension controlling roller 171.

X-rays which are emitted by the x-ray tube 14 during an inspection process should be blocked, and for such purpose, shielding modules 13a and 13b may be installed. The shielding modules 13a and 13b may have at least one curtain structure including lead, and may be installed in the inputting unit 12a and the outputting unit 12b, respectively. The shielding member may be provided at a certain interval, and may have a passing strip that is formed for the inspection target M being transferred.

The x-rays which is emitted by the x-ray tube 14 is detected by the detector 15 after vertically penetrating the inspection targets M and, if necessary, may be emitted in an inclined direction depending on a shape of the inspection targets M.

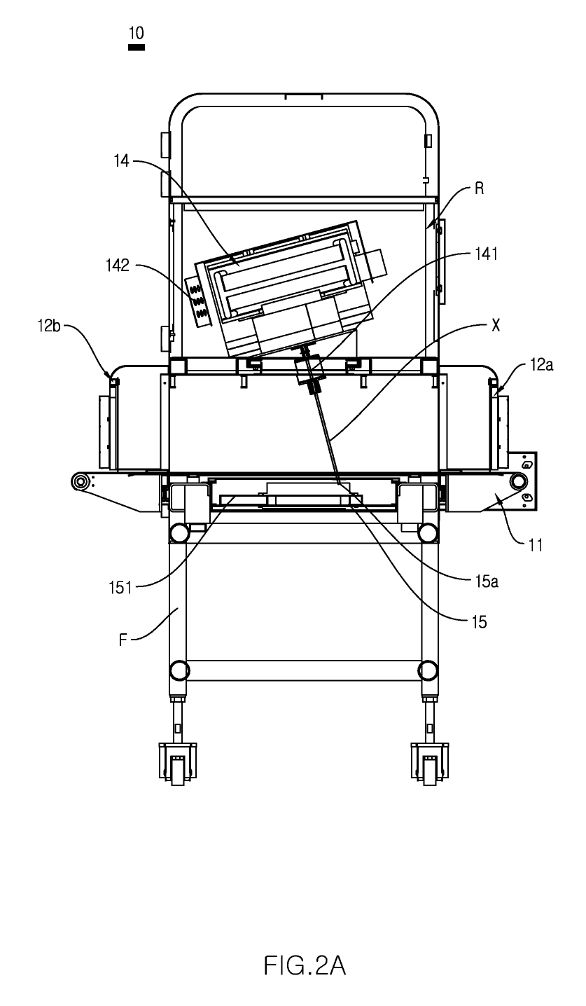

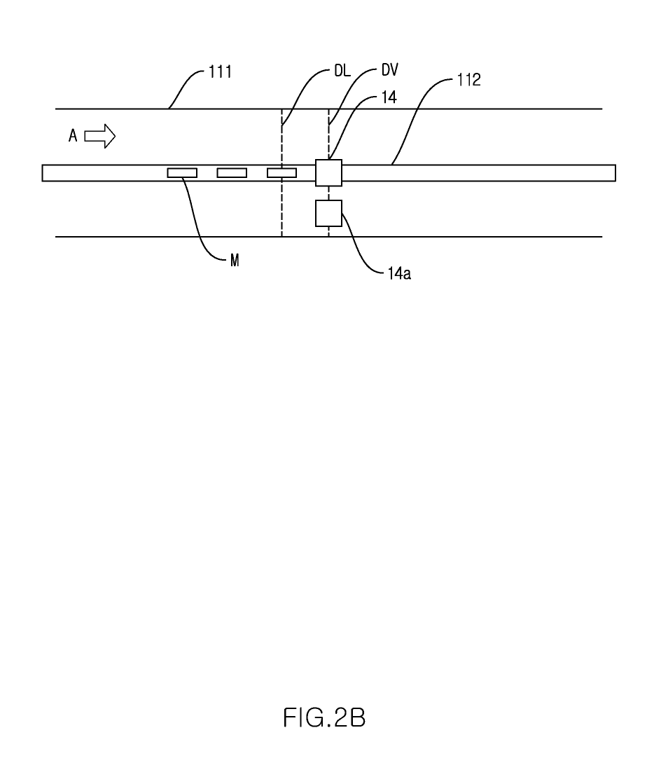

FIGS. 2A and 2B illustrate another embodiment of the x-ray apparatus according to the present invention.

Referring to FIG. 2A, an emission tube 141 through which x-ray X is emitted from the x-ray tube 14, and an adjustment unit 142 which determines an emission direction of the x-ray X from the emission tube 141 may be coupled to the x-ray tube 14. A target metal which emits the x-ray X by collision of electrons may be provided in the emission tube 141, and the adjustment unit 142 may adjust a degree of inclination of the x-ray tube 14 to the conveying module 11. As necessary, the detector 15 may be moved corresponding to the adjustment of inclination of the x-ray tube 14, and a slider 151 may be installed to move the detector 15. The detector 15 may include a sensor such as photo diode, and if the emission tube 141 emits the x-ray X in an inclined direction, the photo diode may be moved to a sensing location 15a.

Referring to FIG. 2B, the inspection targets M may be transferred on the fixing guide 112 formed in the conveyor belt 111 in a predetermined direction A. The x-ray tube 14 may be displaced above the fixing guide 112, and the detector 15 may be displaced below the conveyor belt 111. If an inspection target M is located in a first detecting line DV formed below the x-ray tube 14, the x-ray tube 14 may emit an x-ray, and the detector 15 may detect the inspection target M. In such case, a straight line connecting the x-ray tube 14 and the detector 15 may be perpendicular to the conveyor belt 111, and the detector 15 may provide a plan image. However, depending on the inspection target M, impurities cannot be detected from the plan image. For example, if the inspection target M is present inside a sealed container, and if impurities are located close to a wall of the container, such impurities are hardly detected due to the thickness of the wall. If the container wall has a certain thickness, an x-ray emitted by the x-ray tube 14 penetrates a lateral side of the inspection target M to thereby generate an inclination image. It is advantageous to determine existence or non-existence of defect from the inclination image, if the wall of container has certain thickness. For example, as shown in FIG. 2B, an x-ray emitted by the x-ray tube 14 may have an inclined path to the conveyor belt 111 and the inclined x-ray may be detected at a second detecting line DL which is in advanced location to the first detecting line DV. Alternatively, the x-ray tube 14a may be located out of the path of the fixing guide 112. The detector 15 may be located below in the second detecting line DL. If the x-ray tube 14a is located out of the fixing guide 112, the detector 15 may be located in the first detecting line DV or the second detecting line DL. If the inclination image is generated as above, a straight line connecting the x-ray tubes 14 and 14a and the detector 15 may encounter the conveyor belt 111 at an angle that is not perpendicular to the conveyor belt 111. As necessary, both the inclination image and vertical image may be generated.

A position sensor may be installed in the fixing guide 112, and if the position sensor arrives in the first detecting line DV or the second detecting line DL, a position signal may be transmitted to the x-ray tube 14. Upon receiving of the position signal, the x-ray tube 14 may operate, and accordingly a vertical image or an inclination image may be generated. An angle at which the inclination image is generated may vary depending on a shape of the inspection target M.

Hereinafter, an embodiment of the fixing guide 112 and the shielding module applied to the x-ray apparatus according to the present invention will be described.

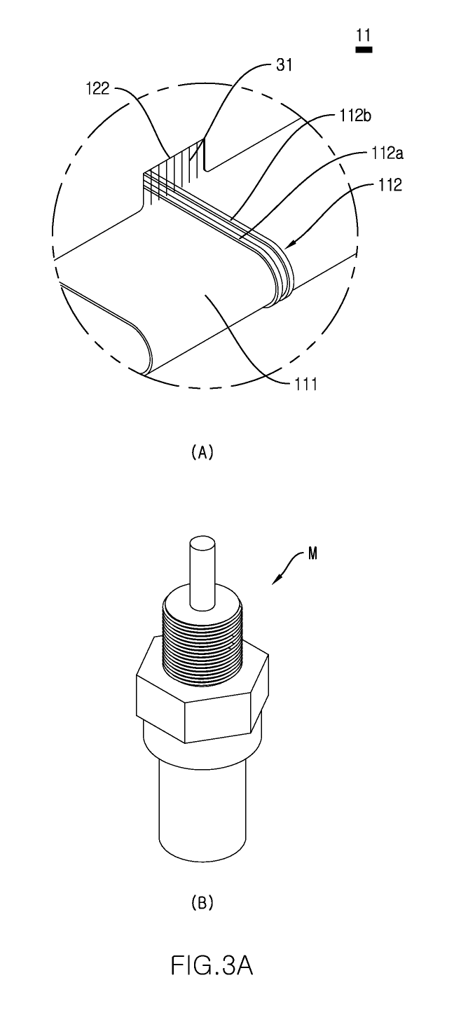

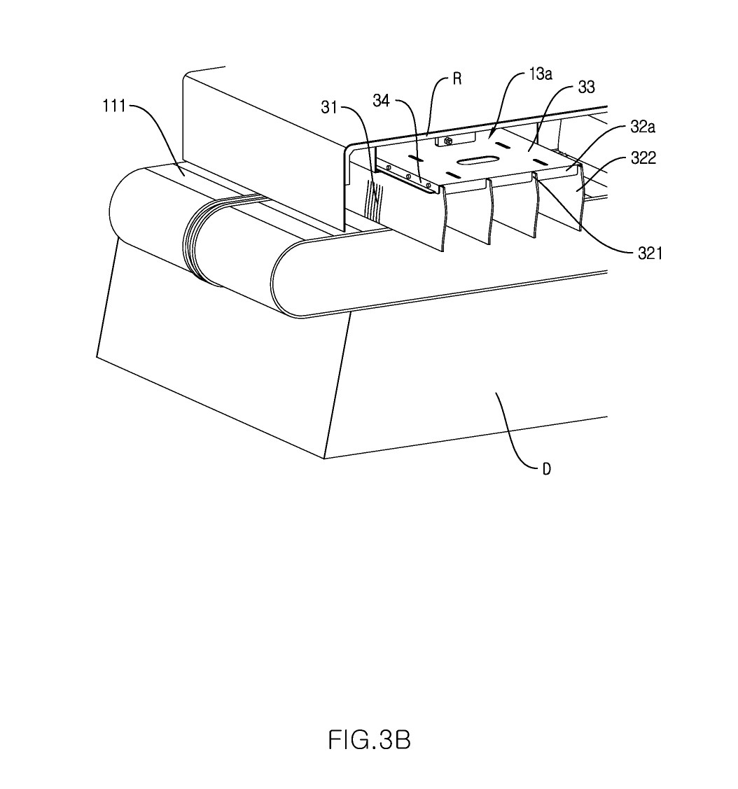

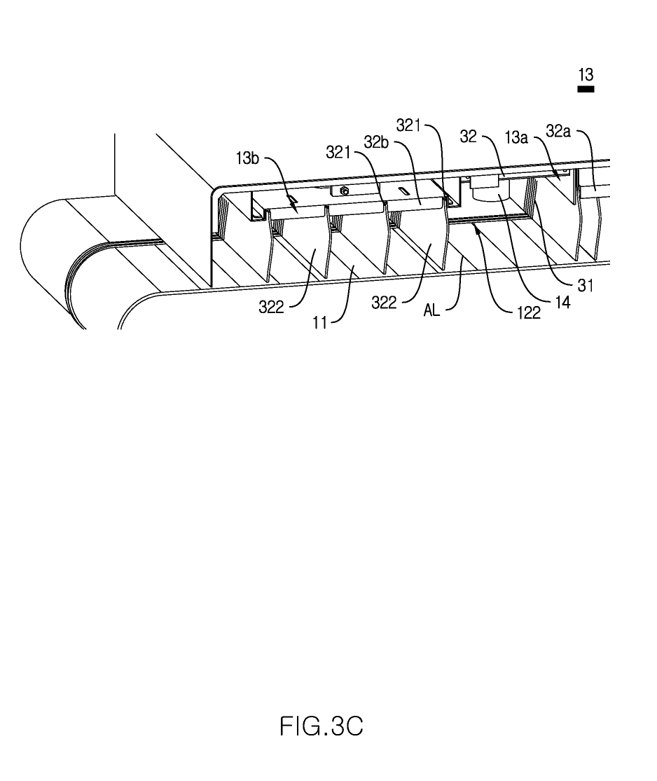

FIG. 3A illustrates an embodiment of a conveyor belt 111 that may apply to the x-ray apparatus according to the present invention.

Referring to (A) in FIG. 3A, the fixing guide 112 may be formed in the conveyor belt 111, and for example, the fixing guide 112 may include a pair of projecting strips that are spaced from each other and extend along a lengthwise direction or moving direction of the conveyor belt 111. Between the pair of strips 112a and 112b, a metal temperature sensor M may be provided as shown in (B) in FIG. 3A and a defect of internal wires may be detected. Spacing interval, width or height of the pair of strips 112a and 112b may depend on the structure of the inspection target M, and the pair of strips 112a and 112b may be integrally formed in the conveyor belt 111. The pair of strips 112a and 112b has a continuous structure along the conveyor belt 111 to arrange a plurality of inspection targets M in a row at a certain interval. The fixing guide 112 may be at least one, and the fixing guide 112 may be shaped like a strip that discontinuously extends as necessary, or may have a proper tray structure configured for fixing the inspection target M, but not limited thereto.

A shielding member 31 in which a plurality of vertical strips is continuously arranged may be provided in the entering portion 122. The size of the entering portion 122 may depend on the shape of the inspection target M, and the shielding member 31 may be shaped to completely block the entering portion 122 by the plurality of strips. The plurality of strips may be bent with resilient or flexible property and the inspection target M may be transferred into the inspection module through the entering portion 122 by bending the strip.

As explained above, a plural of the shielding members 31 may be installed continuously.

FIG. 3B illustrates an embodiment of a shielding structure applied to the x-ray apparatus according to the present invention.

Referring FIG. 3B, the shielding module 13a may include a coupling plate 33 that is shaped like a flat surface. Sliding members 34 may be installed in front and rear sides of the coupling plate 33, and the horizontal coupling member 32a may be displaced at sides the coupling plate 33.

The shielding module 13a may comprise the coupling plate 33, the horizontal coupling member 32a and the sliding members 34. At least one fixing opening 321 may be formed in the horizontal coupling member 32a, and a shielding unit 322 that has a curtain structure may be fixed in the at least one fixing space 321. A door may be installed in the inspection module R to decouple and couple the shielding module 13a, and the shielding module 13a may be decoupled from or coupled to the inspection module R through the sliding members 34 in a sliding manner.

Various types of detachable shielding modules 13a may be applied to the x-ray apparatus according to the present invention, which is not limited by the embodiments provided herein.

FIG. 3C illustrates another embodiment of the shielding module 13a applied to the x-ray apparatus according to the present invention.

Referring to FIG. 3C, shielding modules 13a and 13b may be installed within the inspection module. The shielding modules 13a and 13b may include horizontal coupling members 32a and 32b, fixing space 321 that is formed in the horizontal coupling members 32a and 32b at a certain interval, and a shielding unit 322 that is fixed in the fixing space 321. The horizontal coupling members 32a and 32b may be coupled to the inputting unit or the outputting unit, or may be coupled to a proper fixing frame that is installed in the inspection module. The shielding modules 13a and 13b may be provided in both sides of the x-ray tube 14, and a plurality of shielding units 322 may be installed in parallel at the respective shielding modules 13a and 13b. A shielding member 31 that has a strip structure may be formed in each shielding unit 322. Each shielding units 322 may extend from the horizontal coupling members 32a and 32b to contact the conveyor belt 111 with a bendable structure. As necessary, an inspection target arrangement line AL may be formed in the conveyor belt 111. The inspection target arrangement line AL may be perpendicular to an extension direction of the fixing guide 122. The plurality of shielding units 322 are formed in parallel each other, and the shielding member 31 that has a strip structure and is formed in each shielding units 322 may completely prevent x-ray from being leaked.

The x-ray apparatus according to the present invention may be applied to inspection of various industrial products, for example to inspection of food stored in a container or to inspection of mechanical parts. Depending on inspection targets, high resolution may be required. For example, if the size of impurities to be detected is hundreds of micrometers, a sufficient resolution level for detecting the defect may be required. In general, the resolution of the x-ray apparatus may be determined by a focal spot size or capability of a detector.

According to the present invention, the resolution of the x-ray apparatus or the resolution of a detector may be adjusted depending on inspection targets, and a resolution level may be increased with respect to a target that requires high resolution.

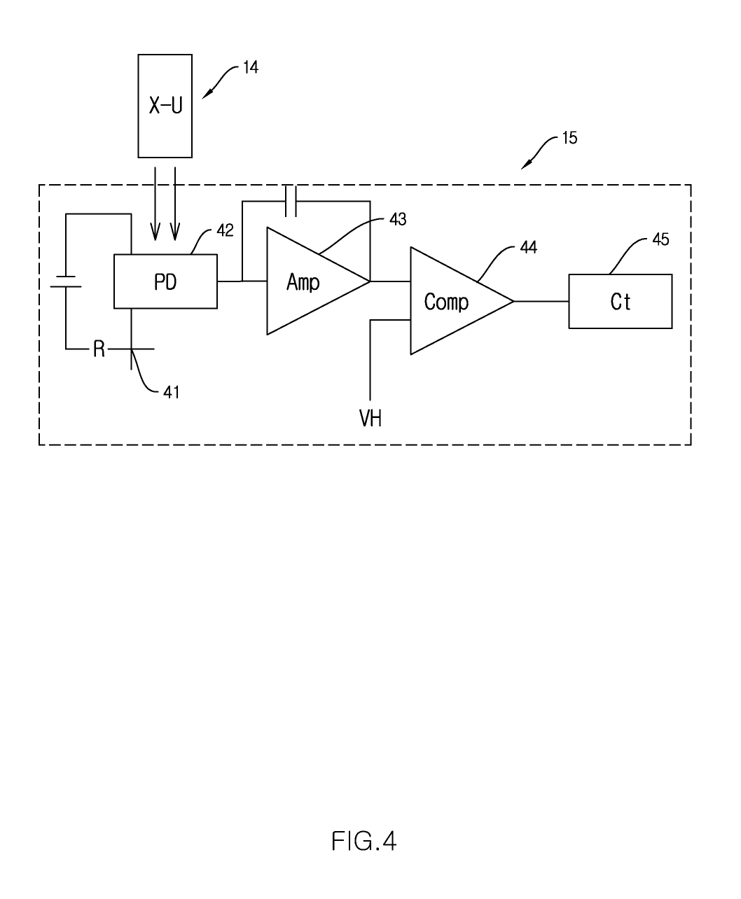

FIG. 4 illustrates an embodiment of a detector with high resolution applied to the x-ray apparatus according to the present invention.

Referring to FIG. 4, a detector 15 may include a sensor 42, a variable power source 41 for adjusting a voltage applied to the sensor 42, an amplifier 43 for amplifying a signal generated by the sensor 42, a comparator 44 for comparing an output signal of the amplifier 43 with a predetermined threshold value VH, and a counter 45 for counting a signal transmitted by the comparator 44.

An x-ray which is emitted by the x-ray tube 14 may be detected by the sensor 42 such as a photo diode through an inspection target. A voltage which is applied to the sensor 42 may be adjusted, and the sensor 42 may generate a photon depending on the strength of x-ray. The voltage which is applied to the sensor 42 may be determined by an inspection target and a size of a defect to be detected. The signal of the sensor 42 may be transmitted to the amplifier 43 to be filtered thereby. The amplified and filtered signal may be transmitted to the comparator 44. The comparator 44 may compare the signal transmitted by the amplifier 43 with a predetermined threshold value VH, and may generate a signal such as 0 or 1 according to the comparison result. The counter 45 may count a digital signal and determine whether to transmit the signal. The sensor 42 may detect the size of x-ray by pixel, and the counter 45 may determine whether there is a signal or noise. The size or threshold value of a variable voltage may be determined in advance by, e.g., a control unit, depending on an inspection target or a type of defect. The detector 15 with the aforementioned configuration has such advantage that enables realization of high resolution and accurate inspection of an inspection target or detected target.

Various detectors 15 may apply to the x-ray apparatus according to the present invention to realize high resolution, and the present invention is not limited to the embodiments provided herein.

The x-ray apparatus according to the present invention improves inspection efficiency by continuously inspecting food or mechanical parts. The x-ray apparatus according to the present invention prevents occurrence of any inspection error that may arise due to a shape of an inspection target, by obtaining an inclination image. The x-ray apparatus according to the present invention may ensure improvement of product quality by continuously inspecting products subject to mass production such as metal temperature sensors for vehicles.

While the foregoing description and drawings represent embodiments of the present disclosure, it will be understood that various additions, modifications and substitutions may be made therein without departing from the spirit and scope of the principles of the present disclosure as defined in the accompanying claims. One skilled in the art will appreciate that the present teaching may be used with many modifications of form, structure, arrangement, proportions, materials, elements, and components and otherwise, used in the practice of the present teaching, which are particularly adapted to specific environments and operative requirements without departing from the principles of the present disclosure. The presently disclosed embodiments are therefore to be considered in all respects as illustrative and not restrictive, the scope of the present teaching being indicated by the appended claims and their legal equivalents, and not limited to the foregoing description.

What is claimed is:

1. An x-ray apparatus comprising:
an inspection module having an x-ray tube and a detector;
a conveying module configured for conveying inspection targets within the inspection module continuously;
an inputting unit and an outputting unit installed at an entrance and an exit of the inspection module;
a shielding member displaced at an entering portion formed in the inputting unit; and
a fixing guide formed in the conveying module.

2. The X-ray apparatus according to claim 1, wherein an emitting angle of the x-ray tube is adjustable to the inspection target.

3. The X-ray apparatus according to claim 1, further comprising shielding modules having at least one shielding unit 322 formed in the inputting unit and the outputting unit.

4. The X-ray apparatus according to claim 1, wherein the fixing guide comprises a pair of strips that extends along a moving direction of a conveyor belt of the conveying module, and is integrally formed in the conveyer belt.
